(19) United States
(12) Patent Application Publication
(10) Pub. No.: US 2002/0074317 A1
(43) Pub. Date: Jun. 20, 2002

(54) NanoEDM: an apparatus for machining and building atomic sized structures

(76) Inventor: Eric Orace Johnson, Champaign, IL (US)

Correspondence Address: Eric Johnson, 403 W. Columbia #2, Champaign, IL, 61820, US

(21) Appl. No.: 09/737,812

(22) Filed: Dec. 18, 2000

(51) Int. Cl. B23K 15/00

(52) U.S. Cl. 219/121.14; 219/121.15; 219/121.18; 219/121.25; 219/121.2

(57) ABSTRACT

An electrical discharge machining probe for creation of micrometer and nanometer scale structures. The probe is further designed to allow ions to be accelerated toward a target surface. The probe is further designed and the ions are further selected and energized to either dislodge atoms from the target surface or to be deposited on the target surface.

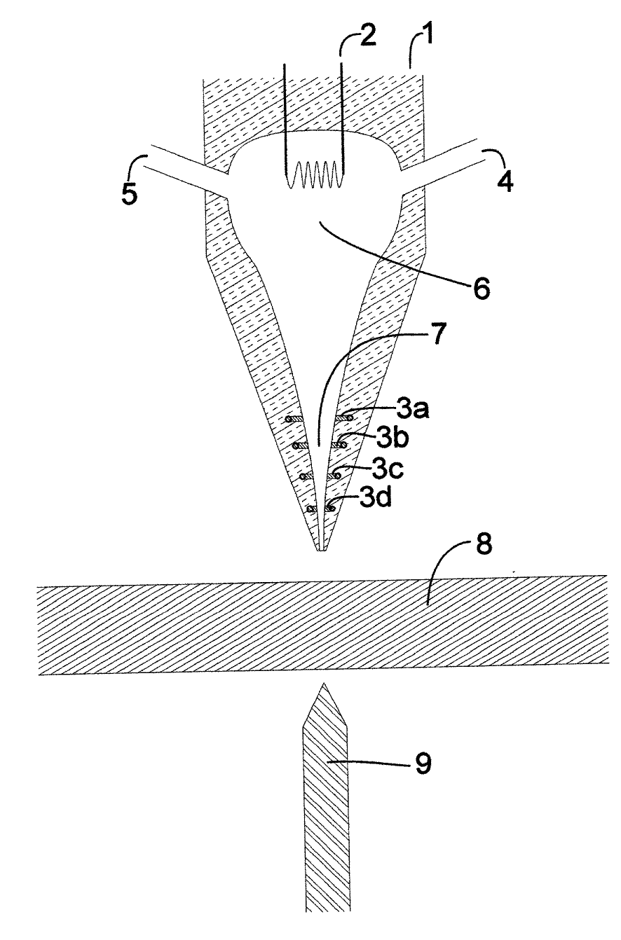

### BACKGROUND OF INVENTION

There is a need for the ability to build structures that are close to the size of atoms. The smaller that electronics circuits are, the less power they use and faster they can run. Researchers in the field of Nano-technology are excited about the potential of electronic and mechanical devices constructed with nanometer precision.

Currently there are few ways to build small devices.

Scanning Probes such as Atomic Force Microscopes and Scanning Tunneling Electron Microscopes scan a fine tip across a surface. We have the technology to position the tip in 3 dimensions with a precision of less than the size of an atom. By applying a proper charge, a single atom may be attached to the tip and dragged across the surface to a desired location. Unfortunately, there is a limited selection of types of atoms that may be dragged and the surface has to be just proper for this to work well. The process is both time consuming and problematic.

A complex gas can be caused to break down between the scanning probe tip and the surface. This results in a portion of what had been a gas molecule to be deposited on the surface. There are a limited number of useful materials that can be built up using this technique.

Lithography has been used with great success to make microelectronic chips with relatively large structures measured in micrometers. Using higher frequencies of light can result in small structures, but even ultraviolet micro-lithography can't create structures as small as a few nanometers. X-ray lithography has the potential to create 3 dimensional structures closer to the nanometer size necessary, but the technology has yet to be developed into a viable nanoconstruction method. All lithography techniques use masks to create patterns. These masks are time consuming to produce and new masks must be created every time any aspect of the item being produced is to be changed.

Current mechanical cutting techniques don't extend into the sub-micrometer scale. It is hard to create cutting and forming tools that small. Wear on the tools rapidly changes their dimensions causing a corresponding loss of precision.

Electron Beam machining can be used to form small holes. In this process, a beam of electrons is focused and accelerated in a vacuum. The electrons travel a relatively large distance—measured in fractions of a meter—as they pass through the magnetic focusing elements. The process must take place in a vacuum. The holes can have very steep sides, but the 10 microns minimum diameter of any hole drilled by this process is far too large for nanometer scale construction. In addition, a large amount of power is required for the amount of material that is removed.

An interesting way to create large structures is to use electrical discharge machining. A conductive probe that is stable at high temperatures is brought near the surface to be carved. An appropriate electrical current is allowed to arc between the probe and the conductive surface. The energy of the spark causes local heating of both the probe and the surface. The surface heats up enough to evaporate or oxidize. A dielectric fluid between the probe and the surface flushes condenses and flushes away the evaporated material while cooling the probe and surface. The probe is moved slightly, another arc forms and more of the surface is removed. The process is rapid and precise. It can leave a very smooth surface. But, because of probe size, placement and wear, microscopic structures can't be formed.

### SUMMARY OF INVENTION

In accordance with the present invention, a probe with an atomic sized tube, hole, passageway or electrode can be used to convey an electronic, ionic, or molecular jet stream at a surface and remove from or apply to said surface very small quantities of material which results in the ability to create nanometer scale structures.

### BRIEF DESCRIPTION OF DRAWINGS

The FIGURE shows a cutaway view of a basic EDM tip. It is composed of an insulator 1. Within the insulator is an ion creation chamber 6 to allow for the creation of free ions and an ion acceleration tube 7. A filament 2 for heating of gasses and production of free electrons is located in the ion creation chamber. Surrounding the ion acceleration tube are acceleration rings 3a-3d. Input port 4 is for the introduction of fluids. Exhaust port 5 is for exhausting waste products from the ion creation chamber. The EDM tip is positioned near a target surface 8 that we wish to reform. Below the target surface is a target conductor 9 for providing a charge to attract and direct the ion stream that the EDM tip produces.

### DETAILED DESCRIPTION

The invention has a source of electrical discharge that is constrained by an insulating channel to a fine point. Surrounding the insulating channel are one or more electrical control rings used for shaping, focusing, accelerating and controlling the beam of electricity. Near the source of electrical discharge are ports to allow gasses or other fluids to be injected.

Basic Operation:

In electrical discharge mode, a current is created from the interior of the probe to the target surface i.e. the substance that we wish to erode. The energy of the discharge is converted into heat in the target surface. This results in the vaporization of the target surface. A surrounding fluid flushes away the vaporized material so that it is not deposited on the target surface. The narrow channel of the acceleration tube and the control rings in the insulator in addition to the small distance between the tip and the surface, cause the electron beam to be fine enough that individually selected atoms may be vaporized.

The Filament:

When heated, the filament will emit electrons that are then accelerated by the voltage potential and the acceleration rings. The filament may be coated with materials that readily emit electrons. The filament may be used to thermally decompose the injected gas into other materials for acceleration. The filament may be used to thermally cause reaction between a plurality of injected gasses into other materials that are then accelerated toward the target surface. The filament may be used to create ions by charging the injected gases or other material either negatively or positively. Undesired material may be removed through an exhaust tube connected to the chamber.

Ion Acceleration Erosion Mode:

A gas or other material may be injected into the ionization chamber. The filament can charge the material, creating ions. The voltage gradient between the filament, the acceleration rings and the target conductor will cause the ions to be accelerated into the target surface. The energy of the accelerated ion and its mechanical force will cause a selected atom to be removed from the target surface.

Ion Acceleration Deposition Mode:

A gas or other material may be injected into the chamber. The filament can charge the material, creating ions. The voltage gradient between the filament, the acceleration rings and the target conductor will cause the ions to be accelerated into the target surface. If the charge and energy level of the ion is correct, instead of removing any atoms from the target surface, the accelerated ion will be lodged on the target surface. In this way, layers of material may easily and precisely be added to the target surface. The deposited materials may be either insulating, conducting or semi-conducting. This allows a complete integrated circuit to be built rapidly on a very small scale.

Slurry Mode:

Small particles of solids may be suspended in a carrier gas which is injected into the ionization chamber. When the gas contacts the hot filament, solids may be evaporated and ionized. This allows solids (and semi-conductors) to be precisely sputtered on the surface. With some materials it is necessary to heat the acceleration tube and other parts of the probe to prevent adhesion of the sputtered material. Alternatively, the pressurized and accelerated gas can carry particles useful for abrasion or particles we wish to deposit on the target surface.

Ion Acceleration Tube Shape:

The tip of the tube can have straight, parallel, smooth walls. If the tube is narrow enough, the ions will be in a line. By preventing ions from being beside each other, the ion stream will be more readily collimated. The transition from the ion creation chamber to the acceleration chamber and then to the tip of the acceleration chamber can be gradual or abrupt. The preferred embodiment is a gradual transition from the ionization chamber all the way to the parallel sides of the narrow tip.

Control Rings:

As the ion passes through the acceleration chamber, its path will be affected by electrostatic and electromagnetic forces created by the acceleration control rings. Properly applied electromagnetic and/or electrostatic fields may be used to focus the ion beam. While the insulating quality of the tip will tend to constrain the ion beam, additional focusing and collimating means keep the energy of the beam from being lost in the tube walls as the ions pass through the accelerator.

Target Conductor:

A target electrode is placed on the opposite side of the target surface from the ion beam. This electrode helps attract the ions to the target surface and focuses the ion stream at the desired spot on the target.

Pulsed Ions:

By altering the flow of ions and energy, the resulting vibration and energy intensities can more effectively remove target material, while also allowing for periods of cooling and debris removal.

Ion Beam as Conductor:

Once a stream of ions is created between the tip and the target, it may be used to conduct extra electricity to the target. When used in this mode, it will function much like a wire electrical discharge machine with an impossibly ultra fine wire.

Neutralization of Used Ions:

After electrons hit a conducting target surface, they are conducted to ground. Resistive and semi-conducting targets can also bleed charge to ground. If the target is an insulator, the surrounding fluid and other grounding electrodes will remove the excess charge so that the ion stream does not lose its full force and focus. The ion stream can switch between positive and negative to allow for better focusing of the ion stream and neutralization of used ions.

Debris Removal and Cooling:

Material which has been removed, loosened or dislodged from the target surface needs to be prevented from being re-deposited on the target surface or NEDM probe. The ions which have been accelerated and have already impacted the target's surface need to be neutralized and removed.

A layer of gas or other fluid between the tip and target surface can condense the evaporated target surface and flush all waste products away. The fluid will also cool the tip and the target surface near where material is being removed. Because the tip is so close to the target surface, it may be necessary to move the tip to allow the removed ions to be flushed away.

Additional flushing and cooling fluid may be injected into the ionizing chamber or between the ionizing chamber and the accelerating tube or into nozzles dedicated to the flushing fluid. The substances flowing through the tip will tend to leave the area, carrying waste products. If desired, a changing mixture of gases, liquids, ions can be sent through the tip to cut and then transport the material. The fluid may also be charged to neutralize the waste ions.

The fluid flow may be pulsed. It is motionless while an electric discharge is evaporating material so that it does not disrupt the ion stream. After the electrical discharge flow resumes to remove the evaporated material.

The fluid can be a dielectric that will allow a higher voltage to build up before any amperage delivers energy to the target surface. After an arc is formed, the fluid may breakdown to become highly conductive. This will help concentrate an electric pulse on the atoms we wish to dislodge. The pressure of a gaseous fluid needs to be chosen to remove the waste products without deflecting the ion beam.

Since some of the debris will be electrically charged, electric and magnetic fields can be used to move waste material away from the tip.

Multiple Ion Accelerators:

An NEDM probe can be built with multiple ion accelerators. Control rings around each accelerator allow them to be independently controlled. By using multiple tips, construction times may be further decreased. An array of a plurality of tips connected to appropriate plurality of ion creation chambers may be used. Each tip may be designed for acceleration of a different type of ion. For instance, ions formed of atoms or molecules will need wider acceleration tubes than free electron ions. Each tip may be optimized for a different function and placed on the same probe. The probe can use some tips for removal of target material while using other tips for addition of material to the target surface. A complete microstructure or nanostructure may be constructed by the time a single probe has finished passing over the target surface.

Tip Angle:

The angle between the flow of ions and the target surface can make a difference. If the ions hit the surface perpendicularly, they will drive a pin hole in the target. If the jet of ions hits the target at less than 90 degrees, it can provide greater erosion efficiency for thin layers of material. The jet make be angled forward, backward or sideways relative to the path of the probe. Each combination of target material, accelerated ion or electron, and the desired result (eroding or depositing) has its own optimum ion stream angle and probe speed.

Scale:

By properly scaling the elements of the design, it may be used for micrometer scale electrical discharge machining (MEDM) probes.

Solid Electrode:

Instead of using an ion beam to conduct the power, a fine, solid conductor can be surrounded by the high temperature insulator. The device functions more like traditional wire electrical discharge machining with the ability to create nanometer scale structures.

Viewing the Target Surface:

An electron microscope can be incorporated into the probe to allow viewing of the target surface.

Construction Techniques:

A positive mold created can be created with a combination of MEDM probes, lithography, traditional milling methods. Mold the cavity portion of a “D” shaped final product in a ceramic material and mate it with a flat ceramic. The control rings may be imbedded in the 2 halves or surround the finished product.

1] A device for creating a narrow electrical discharge comprising:
A means for creating an electrical discharge and an aperture means for constraining said discharge whereby small regions of the target surface may be removed.

2] The device of claim 1 further including a means to create ions whereby atoms or electrons may be created that can be propelled into the target surface.

3] The device of claim 2 further including a means to provide materials to the ion creation means whereby any variety of atoms may be converted into ions.

4] The device of claim 2 further including a means to accelerate said ions whereby a predetermined amount of energy will be imparted to each ion.

5] The device of claim 2 further including a means to control the flow of said ions whereby the flow rate may be adjusted, stopped and started.

6] The device of claim 3 further including a means for reacting said materials into new materials whereby solids and other materials may be propelled to said target surface.

7] The device of claim 1 further including a means to flush away waste products whereby undesired deposits and disruption of the electrical discharge may be avoided.

8] The device of claim 1 further including a means to be cooled by fluid flow whereby the device and said target surface surrounding the region to be removed may be thermally stabilized.

9] The device of claim 1 further including a means to be precisely positioned relative to a target surface whereby the location on the target surface subjected to the electrical discharge may be chosen.

10] The device of claim 1 further including a means to be precisely oriented relative to a target surface whereby the angle of incidence of the electrical discharge may be controlled.

11] A method of material removal comprising the steps of:
creating ions and propelling said ions to a target with predetermined energy whereby atoms may be knocked off and/or evaporated from the target.

12] The device of claim 11 further including the step of providing material for ion creation whereby additional materials may be used by the device.

13] The device of claim 12 further including the step of reacting said material whereby new material may be created.

14] The device of claim 11 further including the step of providing a flow of coolant whereby the device and said target surface surrounding the region to be removed may be thermally stabilized.

15] The device of claim 11 further including the step of removing and/or neutralizing said ions and/or waste products whereby undesired deposits and disruption of the ion flow may be avoided.

16] A method of depositing material comprising the steps of:
creating ions and then propelling said ions to a target with predetermined charge and/or energy whereby said ions may be caused to stick to said target.

17] The device of claim 16 further including a step of providing additional material for ion creation whereby additional materials may be used by the device.

18] The device of claim 17 further including the step of reacting said material whereby new material may be created.

19] The device of claim 16 further including the step of providing a flow of coolant whereby the device and said target surface surrounding the region to be removed may be thermally stabilized.

20] The device of claim 16 further including the step of removing and/or neutralizing said ions and/or waste products whereby undesired deposits and disruption of the ion flow may be avoided.
